(19) United States
(12) Patent Application Publication
(10) Pub. No.: US 2008/0100081 A1
(43) Pub. Date: May 1, 2008

(54) Vehicle interior storage compartment

(75) Inventors: Brian Begg, Holly, MI (US); David M. Failla, Lake Orion, MI (US); John L. Adams, Warren, MI (US); Steve Gage, Utica, MI (US); Herb Stables, North Branch, MI (US); Michael P. Schoemann, Waterford, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: Lear Corporation

(21) Appl. No.: 11/525,427

(22) Filed: Oct. 26, 2006

(51) Int. Cl. B60R 7/04

(52) U.S. Cl. 296/37.7; 296/214

(57) ABSTRACT

A vehicle interior storage compartment includes a recess formed in a vehicle headliner. The recess has a peripheral edge, and a surface of the headliner within the recess defines at least one wall of a storage compartment. A storage compartment cover is attached about a portion of the peripheral edge of the recess. An edge of the storage compartment cover and a portion of the peripheral edge of the recess are spaced apart and define a storage compartment opening therebetween.

### BACKGROUND

Various embodiments of a storage compartment are described herein. In particular, the embodiments described herein relate to an improved overhead storage compartment for a vehicle interior.

The interior of a vehicle typically includes an overhead substrate or headliner. Storage containers, such as overhead consoles, which are mounted to the ceiling of the vehicle are well known. Storage containers which are mounted within openings in the headliner are also known.

For example, U.S. Pat. No. 5,310,237 discloses a storage container mounted to the ceiling of a vehicle using the existing visor mounting apertures. The storage container extends downwardly from the ceiling into the passenger cabin of the vehicle. German Patent No. DE 41 16 758 discloses a storage container mounted to the ceiling of a vehicle within an opening formed in the headliner. It would desirable however, to provide an improved overhead storage compartment for a vehicle interior.

### SUMMARY

The present application describes various embodiments of a vehicle storage compartment for a vehicle interior. One embodiment of the vehicle interior storage compartment includes a recess formed in a vehicle headliner. The recess has a peripheral edge, and a surface of the headliner within the recess defines at least one wall of a storage compartment. A storage compartment cover is attached about a portion of the peripheral edge of the recess. An edge of the storage compartment cover and a portion of the peripheral edge of the recess are spaced apart and define a storage compartment opening therebetween.

Other advantages of the vehicle storage compartment for a vehicle interior will become apparent to those skilled in the art from the following detailed description, when read in light of the accompanying drawings.

### BRIEF DESCRIPTION OF THE DRAWINGS

FIG. 1 is a bottom view of a first embodiment of an overhead storage compartment showing the recess in the headliner.

FIG. 2 is a bottom view of the A-side of the overhead storage compartment cover shown in FIG. 1.

FIG. 3 is a plan view of the B-side of the overhead storage compartment cover shown in FIG. 2.

FIG. 4 is a cross sectional view in elevation of a second embodiment of the overhead storage compartment cover shown in FIG. 1.

FIG. 4A is an enlarged cross sectional view in elevation of the attachment boss of a third embodiment of the overhead storage compartment cover shown in FIG. 1.

FIG. 5 is a cross sectional view in elevation of a fourth embodiment of the overhead storage compartment cover shown in FIG. 1.

FIG. 6 is a cross sectional view in elevation of a fifth embodiment of the overhead storage compartment cover shown in FIG. 1.

FIG. 7 is a cross sectional view in elevation of a portion of a sixth embodiment of the overhead storage compartment cover shown in FIG. 1.

### DETAILED DESCRIPTION OF THE INVENTION

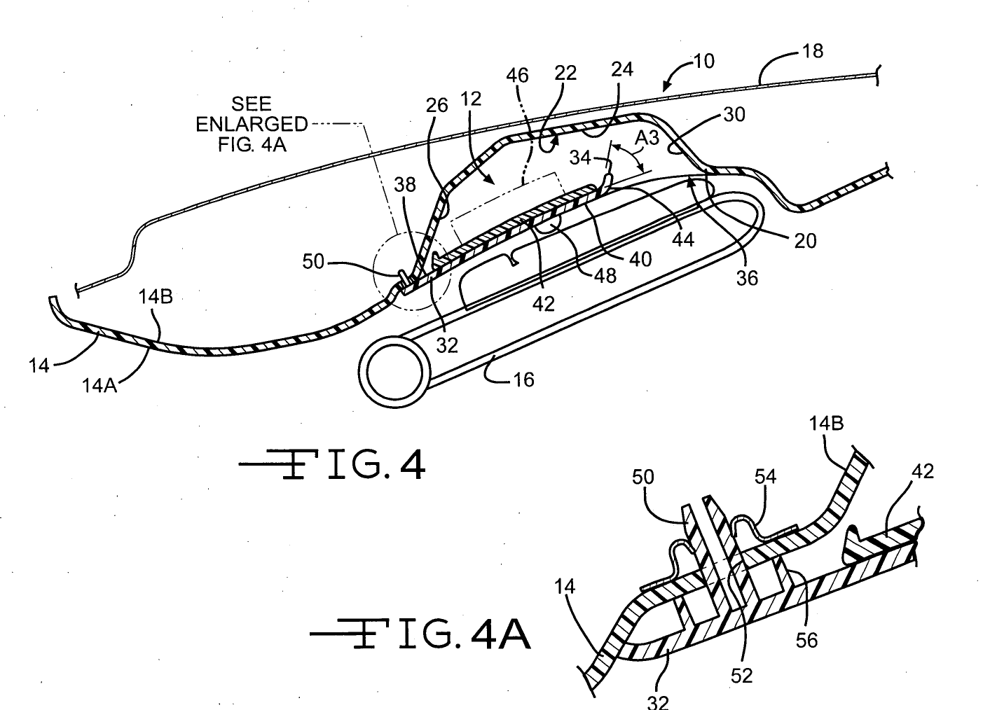

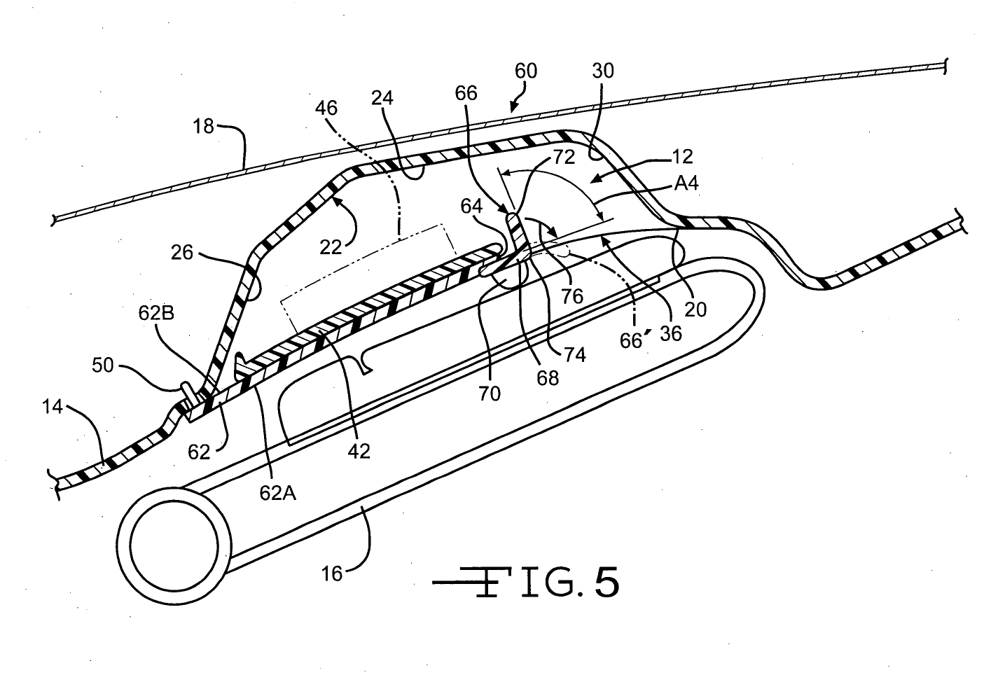

Referring now to the drawings, there is illustrated in FIG. 1 a vehicle interior storage compartment, indicated generally at 10. The illustrated storage compartment 10 includes a recess 12 formed in a vehicle overhead substrate or headliner 14. The exemplary recess 12 illustrated is integrally formed in the headliner 14 during formation of the headliner 14, such as during an injection molding or compression molding process. The headliner 14 includes a B-side surface 14B, best shown in FIG. 4, and may include an esthetically pleasing headliner material (not shown) attached to an A-side surface 14A thereof.

The illustrated storage compartment 10 is shown formed between a visor 16 and the headliner 14 (shown adjacent a vehicle roof 18 in FIG. 4). It will be understood that the embodiments of the storage compartment 10 described herein may be formed at any other desired location within the vehicle.

The illustrated recess 12 includes a peripheral edge 20 and an interior surface 22. The surface 22 defines at least one upper wall 24 of the recess 12, as shown in FIGS. 1 and 4. The surface 22 further defines a rear wall 26, a pair of opposing side walls 28, and a front wall 30.

In the embodiment of the storage compartment 10 illustrated in FIGS. 1 through 3, a storage compartment cover 32 is attached about a portion of the peripheral edge 20 of the recess 12. The illustrated cover 32 defines a bottom wall of the storage compartment 10. The cover 32 includes a forward edge 34 facing the interior cabin of the vehicle (i.e., upwardly as viewed in FIG. 1 and to the right as viewed in FIG. 4). As best shown in FIGS. 1 and 4, the forward edge 34 of the storage compartment cover 32 and a portion of the peripheral edge 20 of the recess 12 define a storage compartment opening 36.

The cover 32, as illustrated in FIGS. 1 through 4, is substantially flat. Alternatively, the cover 32 may have any other predetermined internal and/or external contour. The cover 32 includes a first surface 38 (upwardly facing as viewed in FIG. 4) defining an interior surface of the storage compartment 10 and a second or A-side surface 40 facing the interior cabin of the vehicle. It will be understood that the cover 32 may have a shape other than the shape illustrated. For example, the cover 32 may be substantially rectangular, oval, any other desired polygonal shape, or may have an irregular shape.

The illustrated cover 32 is formed from a first material. The first material of the cover 32 may be any desired substantially rigid material, such as a polymer or plastic. Examples of materials suitable for the cover 32 include polypropylene, thermoplastic elastomer (TPE), thermoplastic elastomer polyolefin, polycarbonate, acrylonitrile butadiene styrene (ABS), polycarbonate ABS, styrene maleic anhydride (SMA), polyphenylene oxide (PPO), nylon, polyester, acrylic, and polysulfone. It will be understood that the A-side surface 40 of the cover 32 may have any desired texture and color, and may include the esthetically pleasing headliner material (not shown) attached thereto.

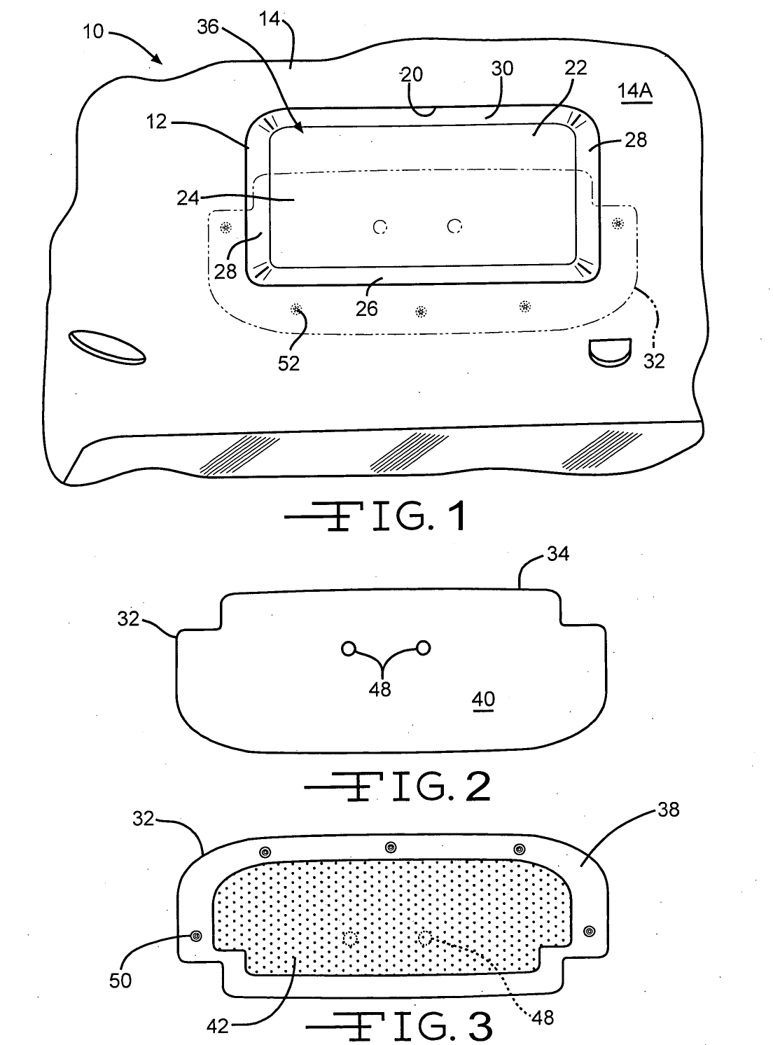

In the embodiments illustrated in FIGS. 3 and 4, a mat 42 is disposed on a portion of the first surface 38 of the cover 32. The illustrated mat 42 is formed from a second material. In one embodiment, the second material is different from the first material. In the illustrated embodiments, the mat 42 is formed from any desired material having anti-buzz, squeak, and rattle (BSR) properties. Examples of such anti-BSR material include TPE, thermoplastic elastomer-ether-ester (TEEE), ethylene propylene diene monomer (EPDM), and thermoplastic vulcanate (TPV). It will be understood that any other desired materials, such as other elastomers and non-elastomers, may be used to form the mat 42.

The mat 42 may be attached to the cover 32 by any desired means, such as for example, by friction or with an adhesive. Alternatively, the mat 42 may be integrally molded to the cover 32, such as in a two-shot molding process. Such a two-shot molding process is described in concurrently filed and co-pending U.S. patent application to Schoemann et al., entitled Vehicle Trim Component Storage Compartment and Method of Making Same, the contents of which are incorporated herein by reference.

In the embodiment illustrated in FIG. 4, the cover 32 includes a lip 44 extending outwardly (upwardly when viewed in FIG. 4) of the first surface 38 toward the storage compartment opening 36. The illustrated lip 44 defines a retainer wall for preventing an object (shown by the phantom line 46 in FIG. 4) from sliding toward the interior cabin of the vehicle (to the right as viewed in FIG. 4). The lip 44 may be disposed at any desired angle A3 relative to the first surface 38 and may extend any desired distance into the opening 36 and toward the upper wall 24. Alternatively, the cover 32 may be formed without such a lip 44.

If desired, the cover 32 may include one or more bumpers 48 for engaging the visor 16 when the visor 16 is in an up or stored position, as illustrated in FIG. 4. In the illustrated embodiments, the bumpers 48 are formed from an anti-BSR material as described above. Bumpers 48 formed from such an anti-BSR material may significantly reduce or eliminate noise (i.e. buzz, squeak, and rattle) that may otherwise occur when the visor 16 contacts the cover 32 during vehicle operation. Alternatively, the bumpers may be formed from any other desired materials, such as other elastomers and non-elastomers.

The bumpers 48 illustrated in FIGS. 2 and 4 are substantially semi-spherical in shape. Alternatively, the bumpers 48 may have any other desired shape and size. The bumpers 48 may be separately formed and attached to the cover 32 by any desired means. Alternatively, the bumpers 48 may be integrally molded to the cover 32, such as in a two-shot molding process.

Referring now to the embodiment illustrated in FIGS. 3, 4, and 4A, the first surface 38 of the cover 32 includes a plurality of outwardly (upwardly as viewed in FIG. 4A) extending bosses 50. The illustrated bosses 50 extend through apertures 52 in the headliner 14. Attachment members 54 may be provided adjacent the B-side surface 14B of the headliner 14 to secure the bosses 50 within the apertures 52. Examples of suitable Attachment members 54 include Palnut® and Speednut® attachments. Alternatively, any other desired attachment member may be provided. Although the embodiment of the cover 32 illustrated in FIG. 3 shows five bosses 50, it will be understood that any desired number of bosses 50 may be provided. It will be further understood that some experimentation may be required to determine the most advantageous number of bosses 50 to be provided on the cover 32.

Referring again to FIG. 4A, the illustrated embodiment of the cover 32 includes a plurality of strengthening members or ribs 56. It will be understood that any desired number of ribs 56 may be provided.

Referring now to FIG. 5, and using like reference numbers to indicate corresponding parts, there is illustrated an elevational view in section, of a portion of an additional embodiment of the storage compartment, indicated generally at 60. As shown therein, the storage compartment 60 includes a cover 62 having an A-side surface 62A, a B-side surface 62B. The cover 62 includes a forward edge 64 facing the interior cabin of the vehicle (i.e., facing to the right as viewed in FIG. 5). In the embodiment illustrated in FIG. 5 the mat 42 is disposed on a portion of the B-side surface 62B of the cover 62. It will be understood that the mat 42 is not required.

In the embodiment illustrated in FIG. 5, a flexible or semi-rigid member 66 is attached to the forward edge 64 of the cover 62. The illustrated semi-rigid member 66 is formed having a predetermined external contour and extends outwardly of the cover 62 and at least partially covers the storage compartment opening 36. The semi-rigid member 66 further defines a storage compartment closure. The semi-rigid member 66 includes a body portion 68 having a bumper 70, and a lip portion 72.

The body portion 68 of the illustrated storage compartment closure 66 is formed adjacent the A-side surface 62A of the cover 62. The lip portion 72 extends outwardly (upwardly when viewed in FIG. 5) relative to the B-side surface 62B toward the storage compartment opening 36. The illustrated lip portion 72 further defines a retainer wall for preventing an object (shown by the phantom line 46 in FIG. 5) from sliding toward the interior cabin of the vehicle (to the right as viewed in FIG. 5). The lip portion 72 may be disposed at any desired angle A4 relative to the B-side surface 62B and may extend any desired distance into the opening 36 and toward the upper wall 24.

If desired, the body portion 68 may include a bumper 70 for engaging the visor 16 when the visor is in an up or stored position, as illustrated in FIG. 5. In the illustrated embodiment, the bumper 70 is formed from an anti-BSR material as described above. Bumpers 48 formed from such an anti-BSR material may significantly reduce or eliminate noise (i.e. buzz, squeak, and rattle) that may otherwise occur when the visor 16 contacts the cover 62 during vehicle operation. Alternatively, the bumpers may be formed from any other desired materials, such as other elastomers and non-elastomers.

The bumper 70 illustrated in FIG. 5 is elongated and has a substantially semi-spherical cross-sectional shape. Alternatively, the bumper 70 may have any other desired shape and size. The bumper 70 may be separately formed and attached to the cover 62 by any desired means. Alternatively, the bumper 70 may be integrally molded to the cover 62, such as in a two-shot molding process.

The illustrated storage compartment closure 66 is substantially flexible or manually deflectable. As used herein, substantially flexible or manually deflectable is defined as manually movable from the closed position, as shown in FIG. 5, to an open position, as shown generally at 66′ in FIG. 5, upon application of a force by a vehicle occupant. Such a force may be applied when inserting or removing the object 46 into or from the storage compartment 60. In the illustrated embodiment, the lip portion 72 adjacent the forward edge 64 defines a living hinge 74.

As best shown in FIG. 5, the living hinge 74 allows the lip 72 to be displaced outwardly to the open position 66′ (in the direction of the arrow 76), or inwardly to the closed position. For example, a vehicle occupant may desire to store a map, a flashlight, sunglasses, or any other object, such as the object 46, within the storage compartment 60. Such a manually deflectable closure 66 then resiliently returns, in a spring-like manner, to the closed position (and thereby to the predetermined exterior contour) upon removal of the applied force and without permanent deformation of the closure 66. The manually deflectable closure 66 allows the vehicle occupant easy access to the storage compartment 60 and provides an efficient, easy to manufacture, and inexpensive closure 66 for the storage compartment 60.

The mat 42 and the closure 66 may be attached to the cover 62 by any desired means, such as for example, with an adhesive. Alternatively, the mat 42 and/or the closure 66 may be integrally molded to the cover 62, such as in a two-shot molding process.

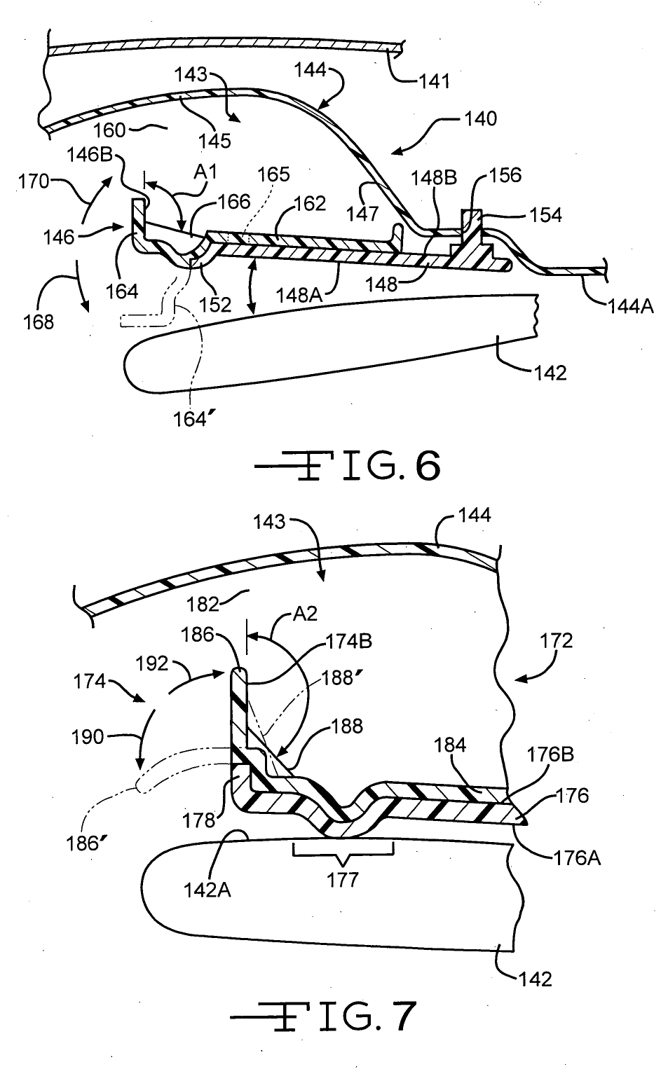

Referring now to FIG. 6, there is illustrated an elevational view in section of another embodiment of the storage compartment, indicated generally at 140. The storage compartment 140 is shown formed between a visor 142 and the vehicle overhead substrate or headliner 144 (shown adjacent a vehicle roof 141). It will be understood that the storage compartment 140 may be formed at any other desired location within the vehicle.

In the illustrated embodiment, the storage compartment 140 includes a recess 143 is formed in the headliner 144. The illustrated recess 143 includes an interior surface 138. The surface 132 defines a first or upper wall 145, a rear wall 147, a pair of opposing side walls 136, and a front wall 138, of which only the rear wall 147 (to the right as viewed in FIG. 6) is illustrated. A substrate 148 defines a bottom wall or cover of the storage compartment 140.

The illustrated substrate 148 includes at least one outwardly extending (upwardly as viewed in FIG. 6) boss 154. The illustrated boss 154 extends through an aperture 156 in the headliner 144 for attaching the substrate 148 to the headliner 144 of the vehicle. The headliner 144 may include an esthetically pleasing headliner material (not shown) attached to the A-side surface 144A thereof.

The illustrated storage compartment 140 includes another embodiment of the manually deflectable storage compartment closure 146 attached to the substrate 148. The illustrated substrate 148 has a predetermined external contour, the B-side surface 148B of which defines a storage surface. The substrate 148 includes an inwardly facing edge portion 152 (i.e., facing the interior cabin of the vehicle, as viewed in FIG. 6).

An opening 160 of the fourth storage compartment 140 is defined between the edge portion 152 of the substrate 148 and the surface 138 of the recess 143. It will be understood that the substrate 148 may include an esthetically pleasing headliner material (not shown) attached to the A-side surface 148A thereof.

The illustrated closure 146 includes a mat portion 162 disposed adjacent the B-side surface 148B of the substrate 148, and a closure body 164. The closure body 164 extends inwardly (i.e., toward the interior cabin of the vehicle, as viewed in FIG. 6) and upwardly (i.e., toward the headliner 144, as viewed in FIG. 6) over the opening 160. In the exemplary embodiment illustrated in FIG. 6, the mat portion 162 and the body 164 are attached to the B-side surface 148B of the substrate 148. If desired, the body 164 may extend upwardly (as viewed in FIG. 6) to the headliner 144.

The B-side surface 146B (i.e., the surface facing away from the interior cabin of the vehicle, as viewed in FIG. 6) of the closure 146 may include at least one strengthening or reinforcing rib 166. The size, thickness, and angle A1 (relative to the upwardly extending portion 164) of an upwardly facing (as viewed in FIG. 6) edge surface of the rib 166 may be varied as desired to achieve the desired flexibility and strength. It will therefore be understood that some experimentation may be required to determine the most advantageous angle A1 of the rib 166.

In the illustrated embodiment, the closure 146 is integrally molded to the substrate 148 according to the two-shot molding process described herein above. It will be understood, however, that the method of forming the fourth storage compartment 140 may also be satisfactorily performed wherein the manually deflectable closure 146 is formed prior to the substrate 148.

In another embodiment of the storage compartment 140, the mat portion 162 and the closure body 164 may be formed as a separate components separated by a space (as indicated by the phantom line 165 in FIG. 6).

In the illustrated embodiment, the mat portion 162 and the closure body 164 are formed from any desired material having anti-buzz, squeak, and rattle (BSR) properties. Examples of such anti-BSR material include TPE, TEEE, EPDM, and TPV. It will be understood that any other desired materials, such as other elastomers and non-elastomers, may be used.

In operation, the illustrated storage compartment closure 146 is manually deflectable from a closed position, as shown in FIG. 6, to an open position, as shown generally by the phantom line 164′ in FIG. 6, upon application of a first force (in the direction of the arrow 168) by a vehicle occupant. Such a force may be applied when inserting or removing an object, such as sunglasses, a map, a flashlight, and the like, into or from the storage compartment 140.

The manually deflectable closure 146 then resiliently returns, in a spring-like manner, to the closed position (and thereby to the predetermined exterior contour) upon removal of the applied force or upon application of a second force (in the direction of the arrow 170) and without permanent deformation of the closure 146. The manually deflectable closure 146 allows the vehicle occupant easy access to the storage compartment 140, and provides an efficient, easy to manufacture, and inexpensive cover or closure 146 for the storage compartment 140.

Referring now to FIG. 7, and using like reference numbers to indicate corresponding parts, there is illustrated an elevational view in section, of a portion of another embodiment of the storage compartment, indicated generally at 172. As shown therein, the storage compartment 172 includes another embodiment of manually deflectable storage compartment closure 174 attached to the substrate 176. The illustrated substrate 176 has a predetermined external contour and includes an A-side surface 176A, a B-side surface 176B, and an edge portion 178.

In the illustrated embodiment, the substrate 176 includes a visor bumper portion 177 for engaging a surface 142A (upwardly facing as viewed in FIG. 7) of the visor 142. If desired, the visor bumper portion 177 may be formed from a material having anti-BSR properties, as described in detail herein above. A visor bumper portion 177 having such anti-BSR properties therefore significantly reduces or eliminates undesirable buzzing, squeaking, and/or rattling due to the visor 142 engaging the substrate 176 as illustrated in FIG. 7.

In the illustrated embodiment, the storage compartment 172 includes the recess 143 formed in the headliner 144. An opening 182 of the storage compartment 172 is defined between the edge portion 178 of the substrate 176 and the headliner 144 of the vehicle.

The illustrated closure 174 includes a mat portion 184 disposed adjacent the B-side surface 176B of the substrate 176, and a closure body 186. The closure body 186 extends inwardly (i.e., toward the interior cabin of the vehicle, as viewed in FIG. 7) and upwardly (i.e., toward the overhead substrate 144, as viewed in FIG. 7) over the opening 182. In the exemplary embodiment illustrated in FIG. 7, the mat portion 184 is attached to the B-side surface 176B of the substrate 176. If desired, the closure body 186 may extend upwardly to the headliner 144.

The B-side surface 174B (i.e., the surface facing away from the interior cabin of the vehicle, as viewed in FIG. 7) of the closure 174 includes at least one strengthening or reinforcing rib 188. The size, thickness, and angle A2 (relative to the upwardly extending portion 186) of an upwardly facing (as viewed in FIG. 7) edge surface of the rib 188 may be varied as desired to achieve the desired flexibility and strength, such as shown at 188′.

In the illustrated embodiment, the closure 174 is integrally molded to the substrate 176 according to the two-shot molding process described herein above. It will be understood, however, that the method of forming the storage compartment 172 may also be satisfactorily performed wherein the manually deflectable closure body 184 is formed prior to the substrate 176. Although not illustrated, the mat portion 184 and the closure body 186 may be formed as a separate components separated by a space.

In operation, the illustrated storage compartment closure 174 is manually deflectable from a closed position, as shown in FIG. 7, to an open position, as shown generally by the phantom line 186′ in FIG. 7, upon application of a first force (in the direction of the arrow 190) by a vehicle occupant.

The manually deflectable closure 174 then resiliently returns, in a spring-like manner, to the closed position upon removal of the applied force or upon application of a second force (in the direction of the arrow 192) and without permanent deformation of the closure 174.

It will be understood that the storage compartment covers described herein may be formed having any desired number of semi-rigid members or closures, such as for example two or more semi-rigid members or closures disposed in a side-by-side arrangement.

The storage compartment 10, 60, 140, 172 comprising a recess 12 formed in the headliner 14 of a vehicle is advantageous over prior art designs. Such compartments 10, 60, 140, 172 are formed in the headliner 14 during formation of the headliner 14, thereby eliminating the need for additional tools, component parts, or assembly steps to provide and install a separately formed storage compartment or console within or adjacent the headliner.

The principle and mode of operation of the overhead storage compartment for a vehicle interior has been described in its various embodiments. However, it should be noted that the overhead storage compartment described herein may be practiced otherwise than as specifically illustrated and described without departing from its scope.

What is claimed is:

1. A vehicle interior storage compartment comprising:
a recess formed in a vehicle headliner, said recess having a peripheral edge, and a surface of said headliner within said recess defining at least one wall of a storage compartment; and
a storage compartment cover attached about a portion of said peripheral edge of said recess, an edge of said storage compartment cover and a portion of said peripheral edge of said recess being spaced apart and defining a storage compartment opening therebetween.

2. The storage compartment according to claim 1, wherein said storage compartment cover defines a bottom wall of said storage compartment.

3. The storage compartment according to claim 2, wherein said at least one wall is an upper wall of said storage compartment.

4. The storage compartment according to claim 3, wherein said surface of said headliner within said recess further defines opposing side walls and a rear wall of said storage compartment.

5. The storage compartment according to claim 1, wherein said storage compartment cover includes a first surface defining an interior surface of said storage compartment, said cover being formed from a first material, storage compartment further including a layer of a second material disposed on a portion of said first surface of said storage compartment cover.

6. The storage compartment according to claim 5, wherein said second material is different from said first material.

7. The storage compartment according to claim 5, wherein said second material has anti-buzz, squeak, and rattle properties.

8. The storage compartment according to claim 5, wherein said layer of a second material is integrally formed with said cover.

9. The storage compartment according to claim 1, wherein said storage compartment cover includes a first surface defining an interior surface of said storage compartment, and wherein said cover further includes a lip portion extending outwardly of said first surface toward said storage compartment opening.

10. The storage compartment according to claim 9, wherein said lip defines a retainer wall of said storage compartment.

11. The storage compartment according to claim 9, wherein said storage compartment cover includes a second surface facing an interior cabin of a vehicle, and wherein said cover further includes a bumper portion extending outwardly of said second surface toward said interior cabin of said vehicle.

12. The storage compartment according to claim 11, wherein said bumper portion is formed from a material having anti-buzz, squeak, and rattle properties.

13. The storage compartment according to claim 12, wherein said bumper portion is integrally formed with said cover.

14. The storage compartment according to claim 1, wherein said storage compartment cover includes a first surface defining an interior surface of said storage compartment, and wherein said cover further includes a semi-rigid member extending outwardly of said first surface and at least partially covering said storage compartment opening to define a storage compartment closure, said semi-rigid member being manually deflectable between a closed position and an open position.

15. The vehicle trim component according to claim 14, wherein said semi-rigid member has a structure allowing said semi-rigid member to be manually deflected between said closed position and said open position such that no portion of said semi-rigid member is permanently deformed during said manual deflection.

16. The vehicle trim component according to claim 14, wherein said semi-rigid member is manually deflectable to said open position upon application of a first force by a vehicle occupant, said semi-rigid member resiliently returning to said closed position upon application of a second force by the vehicle occupant.

17. The vehicle trim component according to claim 14, wherein said semi-rigid member is manually deflectable to said open position upon application of a force by a vehicle occupant, said semi-rigid member resiliently returning to said closed position upon removal of said force by the vehicle occupant.

18. A vehicle interior headliner comprising:
a headliner substrate having a recess formed therein, said recess having a peripheral edge, and a surface of said headliner within said recess defining at least one wall of a storage compartment; and
a storage compartment cover attached about a portion of said peripheral edge of said recess, an edge of said storage compartment cover and a portion of said peripheral edge of said recess being spaced apart and defining a storage compartment opening therebetween.

19. The headliner according to claim 18, wherein said at least one wall is an upper wall of said storage compartment.

20. The headliner according to claim 18, wherein said surface of said headliner within said recess further defines opposing side walls and a rear wall of said storage compartment, and said storage compartment cover defines a bottom wall of said storage compartment.
